(19) United States
(12) Patent Application Publication
(10) Pub. No.: US 2015/0033209 A1
(43) Pub. Date: Jan. 29, 2015

(54) Dynamic Cluster Wide Subsystem Engagement Using a Tracing Schema

(71) Applicant: NETAPP, INC., Sunnyvale, CA (US)

(72) Inventors: Clifford Conklin, Durham, NC (US); Kai Tan, Cary, NC (US); Pranab Patnaik, Cary, NC (US)

(73) Assignee: NETAPP, INC., Sunnyvale, CA (US)

(21) Appl. No.: 13/951,675

(22) Filed: Jul. 26, 2013

(51) Int. Cl. G06F 11/36

(52) U.S. Cl. CPC G06F 11/3636
USPC 717/128

(57) ABSTRACT

A method of invoking an action in response to encountering a tracepoint of an executing application including: encountering a tracepoint of an executing application at a processor of a computer node; receiving tracepoint data at a tracepoint interpretation utility, wherein the tracepoint data includes metadata that describes the state of the processor; analyzing the metadata associated with the tracepoint data to determine whether the metadata further includes action data that describe whether further action should be taken, wherein the action data describes an action other than buffering the tracepoint data; and when it is determined that the metadata includes action data, invoking one or more actions associated with the action data.

### TECHNICAL FIELD

The present disclosure relates generally to computing system clusters and, more particularly, to processing tracepoints encountered in an executing application.

### BACKGROUND

Tracepoints are generally included in an application program to assist software developers in determining how the application entered an unintended state. Tracepoints can assist debugging of application code by logging data describing the application's state. The logged data, in some cases, may be loaded into a debugging application that allows a software developer to step through the application and determine how the error state was encountered. In some cases, tracepoints are included in the application as the compiler converts the application code in an object file. In other cases, tracepoints may be identified by a software developer. Tracepoints included by the compiler are usually static in that they cannot be modified once inserted into the application. Static tracepoints added by a compiler, however, may be controlled dynamically. Dynamic control of tracepoints offer an additional flexibility of only logging data when activated. Further, dynamic control of tracepoints may also allow for logging various levels of detail.

In complicated computer systems, such as systems that include multiple computer nodes in a cluster, tracepoints logging an application state in one node may not provide sufficient information to allow a developer to identify the source of a problem. This is because tracepoints in prior art systems are not capable of performing additional actions outside of logging tracepoint data.

Accordingly, it would be desirable to provide improved methods and systems that allow tracepoints to affect the system by, for example, invoking one or more actions in applications executing in the cluster.

### BRIEF DESCRIPTION OF THE DRAWINGS

FIG. 1 illustrates a diagram of an example computing system according to some embodiments.

FIG. 2 is a simplified block diagram of a system that shows an example relationship among tracing infrastructures included in the nodes of cluster according to some embodiments.

FIG. 3 illustrates an example method according to some embodiments.

FIG. 4 illustrates an example method according to some embodiments.

### DETAILED DESCRIPTION

In the following description, specific details are set forth describing some embodiments consistent with the present disclosure. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Various embodiments of the present disclosure provide for techniques that allow a tracepoint of an executing application to cause either the executing application or another application to invoke actions. Actions can also be invoked at applications in other nodes in the cluster. Generally, the cluster includes a plurality of nodes that can each function as separate computer systems or as a single computer system. Each node includes a storage unit, a memory unit, and at least one processor. The storage unit can include a storage controller and an array of storage drives (e.g., hard disk drives or solid state drives). The memory unit can include a plurality of memory cells located on one or more memory hardware components for storing executing applications, data, and other information. The processor can include one or more processors configured to process instructions that make up applications executing on the node.

Applications executing on a node are stored in the memory unit. The memory unit also stores data that the application is presently processing and metadata that describes the state of the processor. In some embodiments, the metadata also describes the states of the memory, storage units, and operating parameters. The executing applications can be configured to log tracepoints that are included in the applications' instructions.

Tracepoints are generally static and included in an application at compile time when the application code is converted into an object file. Tracepoints, while static, can be controlled dynamically to perform a variety of functions such as, for example, logging data and invoking actions. In some embodiments, metadata stored in the memory unit includes parameters that are used to dynamically control the tracepoints in the application. The parameters can correspond to a behavior table that describe various tracepoint behaviors such as, for example, data logging, the type of data to log, or whether additional actions should be invoked.

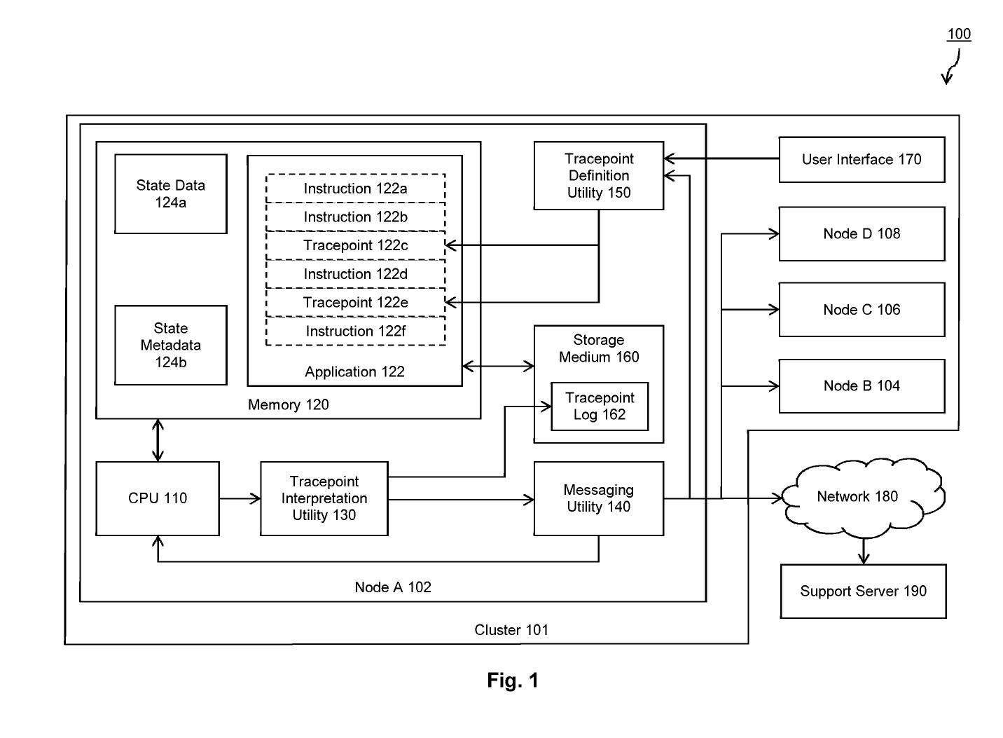

In some embodiments, applications that execute on a node have one or more tracepoints that can be controlled dynamically. The tracepoints are included with the instructions that make up the program and are encountered by the processor as it processes each instruction. When a tracepoint is encountered, the processor calls upon a tracepoint interpretation utility to process the tracepoint. The tracepoint interpretation utility is shown, for example, in FIG. 1.

In processing a tracepoint, the tracepoint interpretation utility receives data and metadata from the processor associated with the tracepoint. The tracepoint interpretation utility logs the data and metadata in a tracepoint log that can be stored, for example, in a buffer in memory or in a data file on the storage unit. The tracepoint interpretation utility also analyzes the tracepoint data and metadata to determine whether the tracepoint includes a further action to be taken.

Further actions may include, for example, an indication to enable or disable one or more tracepoints, an indication to enable or disable one or more actions associated with a tracepoint, an indication to modify the amount and type of data and metadata to store in a tracepoint log, or an indication to send a message to other applications executing on nodes within the cluster. Further actions may also include an indication to provide tracepoint data to a support server.

The various embodiments provide one or more advantages over conventional systems. For example, the embodiments allow a tracepoint to affect a change throughout a cluster. This can be helpful to software developers in diagnosing an error that occurs during an application's execution. For instance, if an application in a node attempts to write to a data file in an attached storage controller and receives a null pointer in response to requesting a file handle, the tracepoint encountered in processing the resulting error state can send a message throughout the cluster to activate tracepoints associated with accessing file handles on the same storage controller. In this way, multiple tracepoints can be activated through encountering a single error state. This may allow a developer to log data about the system's state each time the storage controller is accessed. This additional log data can then be used by the developer to diagnose and fix the source of the error.

While the example provided above is discussed with respect to processing a tracepoint and its associated data, it should be noted that the scope of embodiments is not so limited. For example, while the tracepoint interpretation utility is described above as being a component separate from the memory and processor, a person of ordinary skill in the art will realize that the tracepoint interpretation utility can be executed as an application that utilizes the same memory unit and processor as other executing application on the node. Further, a person of ordinary skill in the art will understand that a node may include more than one tracepoint interpretation utility and that each tracepoint interpretation utility may process tracepoint data in a specific manner different from other tracepoint interpretation utilities.

FIG. 1 illustrates a diagram of an example computing system 100 according to some embodiments. System 100 includes cluster 101 that includes node A 102, node B 104, node C 106, and node D 108. In some embodiments, nodes 102-108 can be configured to function as either a single computer system or as multiple computer systems. Further, each of nodes 104, 106, and 108, as well as other nodes not depicted here, may include the components of node A 102. The nodes 102-108 may include any appropriate computer hardware and software. For example, nodes 102-108 can be configured to execute any of a variety of operating systems, including the Unix™, Linux™, and Microsoft Windows™ operating systems.

In some embodiments, system 100 also includes network 180. Network 180 can include any network capable of transmitting data between computer systems. Such networks may include, for example, a local area network (LAN), an Ethernet subnet, a PCI or PCIe subnet, a switched PCIe subnet, a wide area network (WAN), a metropolitan area network (MAN), the Internet, or the like. Additionally, network 180 may be used to transmit data from one or more of the nodes to a server computer such as, for example, support server 190 or another computer system. Further, while not shown in FIG. 1, nodes 104, 106, and 108, as well as other nodes not shown here may also be connected to network 180.

In some embodiments, cluster 101 may also include user interface 170. User interface 170 may include human interface devices such as, for example, a mouse, keyboard, trackball, etc. User interface 170 may also include a graphical interface that allows a user to interact with one or more nodes in a cluster. Such a graphical user interface may be displayed at a monitor local to the node 102 or remotely via network 180. While user interface 170 is shown in system 100 as interacting with node 102, user interface 170 may also be used to interact with other nodes such as, for example, nodes 104, 106, and 108.

Node A 102 is an example node in cluster 101. As mentioned above, clusters may include multiple nodes and each node may include components similar to those shown in node A 102. Node A 102 includes CPU 110, memory 120, storage medium 160, tracepoint interpretation utility 130, messaging utility 140, and tracepoint definition utility 150. Each of these components and their interactions are described as follows.

Storage medium 160 may include storage objects comprising one or more storage volumes, where each volume has a file system implemented on the volume. A file system implemented on storage medium 160 may provide multiple directories in a single volume, each directory containing various filenames. A file system provides a logical representation of how data (files) are organized on a volume where data (files) are represented as filenames that are organized into one or more directories. Examples of common file systems include New Technology File System (NTFS), File Allocation Table (FAT), Hierarchical File System (HFS), Universal Storage Device Format (UDF), Unix™ file system, and the like. For the Data ONTAP™ storage operating system (available from NetApp, Inc. of Sunnyvale, Calif.) which may implement a Write Anywhere File Layout (WAFL™) file system, there is typically a WAFL™ file system within each volume, and within a WAFL file system, there may be one or more logical units (LUs). The scope of embodiments is not limited to any particular storage operating system or file system.

In some embodiments, storage medium 160 may include tracepoint log 162. Tracepoint log 162 stores tracepoint data associated with a tracepoint encountered while an application is executing. Tracepoint data may include, for example, state data 124a and state metadata 124b that are described in more detail, below. In some embodiments, tracepoint log 162 may be provided to a support server as a result of a tracepoint invoking an action.

Memory 120 includes one or more memory hardware components that can function as one or more memory units. Memory hardware components may include, for example, RAM, ROM, EPROM, flash memory, or the like. The memory units may be represented as one or more contiguous blocks with multiple cells, each cell configured to store data. The data may include an application loaded from a storage unit such as, for example, storage unit 160. Applications loaded into memory unit 120, such as application 122 can include any type of compute program that includes instructions that can be executed by CPU 110. Application 122 is a representation of one of many applications executing on node A 102. Application 122 includes instructions 122a, 122b, 122d, and 122f that are processed by CPU 110.

Application 122 also includes tracepoints 122c and 122e that are also processed by CPU 110. While tracepoints 122c and 122e are represented here as separate from instructions, tracepoints in general may be implemented as instructions that cause the processor to act in a certain manner. For example, tracepoints may be implemented as a processor interrupt or the like that cause the processor to pause application execution while data associated with the tracepoint is written to a data buffer in memory 120 or a data file in storage medium 160 (e.g., tracepoint log 162).

The data associated with a tracepoint may include, for example, state data 124a that describes the state of CPU 110. The state of CPU 110 may be described by values stored in registers associated with CPU 110 or values stored at memory 120 that represent the results of processing one or more previous instructions. The data associated with a tracepoint may also include, for example, state metadata 124b that describes other aspects of the node A 102 such as, for example, applications currently executing, the amount of memory utilized, the load on CPU 110, the state of a network connectivity device, the state of connected devices, the number and type of client devices requesting data, and other information about the overall state of the system. State metadata 124b may also include action data associated with a particular tracepoint. The action data is described in further detail, below.

CPU 110 includes one or more processing cores configured to process instructions of an application. CPU 110 is also configured to process one or more tracepoints that are encountered among the instructions of an executing application. CPU 110 may include any type of processing unit suitable to process instructions from an application. When an instruction is encountered, for example, CPU 110 executes the instruction via one of its processing cores and continues with processing the next instruction. When a tracepoint is encountered, however, CPU 110 may process the tracepoint by, for example, sending state data 124a and state metadata 124b to another component such as, for example, tracepoint interpretation utility 130. In some embodiments, however, CPU 110 may perform the functionality of tracepoint interpretation utility 130 directly rather than calling on another component. Once the tracepoint is processed, CPU 110 will continue to process the next instruction or tracepoint in application 122.

Tracepoint interpretation utility 130 is configured to receive tracepoint data from CPU 110. As described above, the tracepoint data includes state data that indicates the state of the processor and state metadata that may indicate, among other things, the state of the overall environment. This data may be stored in a data buffer in memory 120 or in a data file such as, for example, tracepoint log 162. Whether the tracepoint data is logged may depend on flags associated with the tracepoint that can indicate the type and level of data to store for an encountered tracepoint. The flags for each tracepoint may be stored in state metadata 124b. As will be described below, the flags of a tracepoint may modified to affect, for example, whether the tracepoint is active, the type of tracepoint data that is logged, and whether to perform other functions associated with the tracepoint.

The tracepoint data may also include action data. The action data may be included with, for example, the state metadata. The action data describes one or more actions that may be invoked in cluster 101. Actions that may be invoked include, for example, activating or deactivating tracepoints, activating or deactivating invocation of actions associated with a tracepoint, modifying the level of detail stored when a tracepoint is encountered, sending messages within the current node or to another node in the cluster, modifying data or instructions in an application, launching an application, or the like.

In some embodiments, action data is correlated with values in an action table. The action table may include a number of values and one or more actions associated with each value. Instead of the action data including particular actions, the action data may include one or more values from the action table. Upon determining whether one or more action values exist in the action data, tracepoint interpretation utility 130 may invoke the actions corresponding to the action values.

In some embodiments, node A 102 includes messaging utility 140. While messaging utility is represented in system 100 as a separate component, its functionality may be carried out by CPU 110 or tracepoint interpretation utility 130. Messaging utility 140 is configured to process one or more actions associated with the action data. The actions may be received from, for example, tracepoint interpretation utility 130. As described above, actions may include sending messages within the current node or another node. Messaging utility 140 is configured to send these messages.

For example, action data may indicate an action to modify a tracepoint in one or more applications in the current node. In this case, a message may be sent to, for example, tracepoint definition utility 150 that is configured to activate, deactivate, or modify tracepoints and their associated data. In another example, action data may indicate an action to modify one or more tracepoints in one or more other nodes such as, for example, nodes 104-108. In this case, messaging utility 140 may send a message to each node indicating the tracepoints to be modified. In yet another example, action data may indicate an instruction that is to be executed by the current node or another node. In this case, messaging utility 140 may, for example, send the instruction directly to CPU 110, send the instruction as an event to be processed by an application, or send the instruction to another node for processing. In yet another example, action data may indicate an action to transmit the tracepoint data (e.g., state data 124a and state data 124b) to a support server such as, for example, support server 190. In response, support server 190 send a message to the cluster to activate a number of tracepoints. The actions discussed herein are merely examples and are not intended to limit the embodiments in any way.

In some embodiments, node A 102 may include tracepoint definition utility 150. In other embodiments, the functionality of tracepoint definition utility 150 may be carried out by another component or directly by CPU 110. Tracepoint definition utility 150 is configured to receive commands to activate, deactivate, or otherwise modify tracepoints for applications executing with node A 102. The commands may be provided by a user via user interface 170 or may be received as part of invoking actions derived from action data associated with an encountered tracepoint. Modifications of tracepoints may include, for example, modifying whether a tracepoint is processed (e.g., active state versus inactive state), modifying whether actions associated with a tracepoint are invoked, modifying the type and level of data logged with when a tracepoint is encountered, or modifying the URL of a support server accessible by a tracepoint. These modifications of tracepoints are provided as examples and are not intended to limit the variety of ways that tracepoints can be modified.

While not shown in system 100, multiple client computers may communicate with cluster 101 via network 180 to complete operations. For example, cluster 101 may implement a Network Attached Storage (NAS) system or a Storage Area Network (SAN) system that is accessible to remote clients. Cluster 101 may instead implement a web server or another type of server available via network 180.

The scope of embodiments is not limited to the particular architecture of system 100. For instance, other systems may include additional clusters, each server being similar to cluster 101. While cluster 101 only shows four nodes 102-108, it is understood that any appropriate number of nodes may be used with various embodiments.

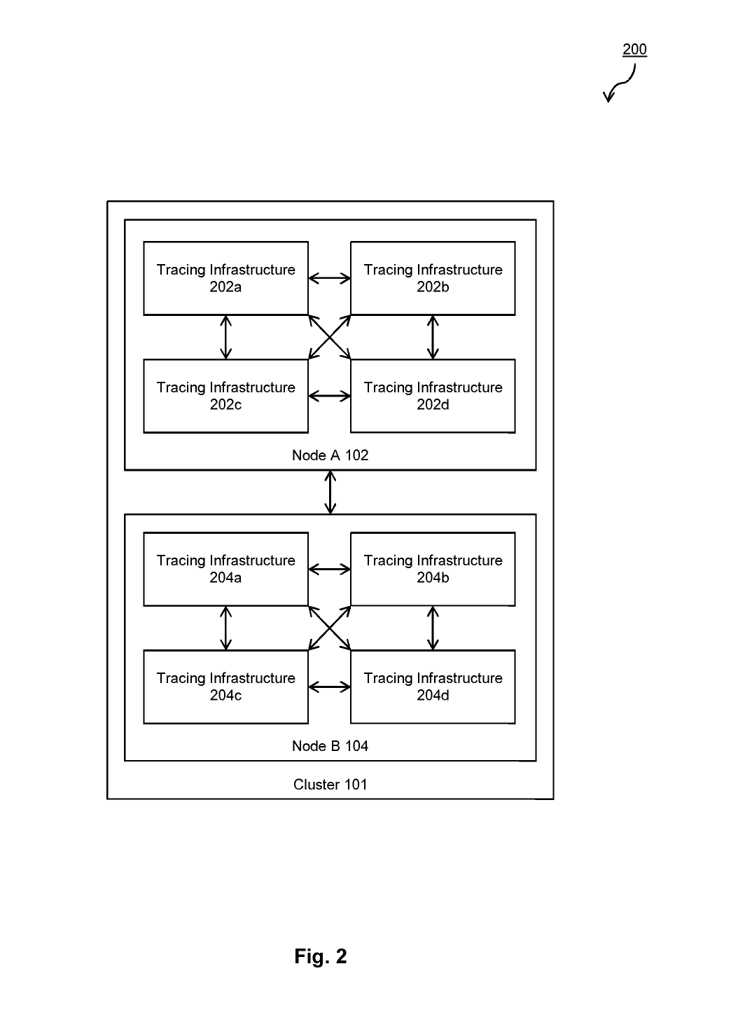

FIG. 2 is a simplified block diagram of system 200 that shows an example relationship among tracing infrastructures included in the nodes of cluster 101 according to some embodiments. Similar to system 100, system 200 includes cluster 101 and nodes A 102 and B 104. Cluster 101 in system 200 may include more than two nodes. Shown in each of nodes A 102 and B 104 is a tracing infrastructure relationship according to an embodiment. Node A 102 includes, for example, tracing infrastructures 202a-d. Likewise, node B 104 includes tracing infrastructures 204a-d.

A tracing infrastructure is, generally, a component or group of components in a node or an application executing on a node that allow a user, a support server, or a node to modify the tracepoints in an application. An example tracepoint infrastructure at the node level may include, for example, tracepoint interpretation utility 130, messaging utility 140, and tracepoint definition utility 150. While these components are separate in system 100, the functionality of these components can be included in a single or multiple different components. Further, the functionality of these components can be unique to each executing application.

In node A 102, for example, tracing infrastructure 202a can interact with any other tracing infrastructures included in cluster 101. Tracing infrastructure 202a can also interact with any tracing infrastructure in node B 104 such as, for example, any one of tracing infrastructures 204a-d. The tracing infrastructures 202b-d and 204a-d may also interact with any other tracing infrastructures in similar manner. In this way, action data associated with a tracepoint processed by, for example, tracing infrastructure 202a can affect the way tracepoints are processed in any other tracing infrastructure.

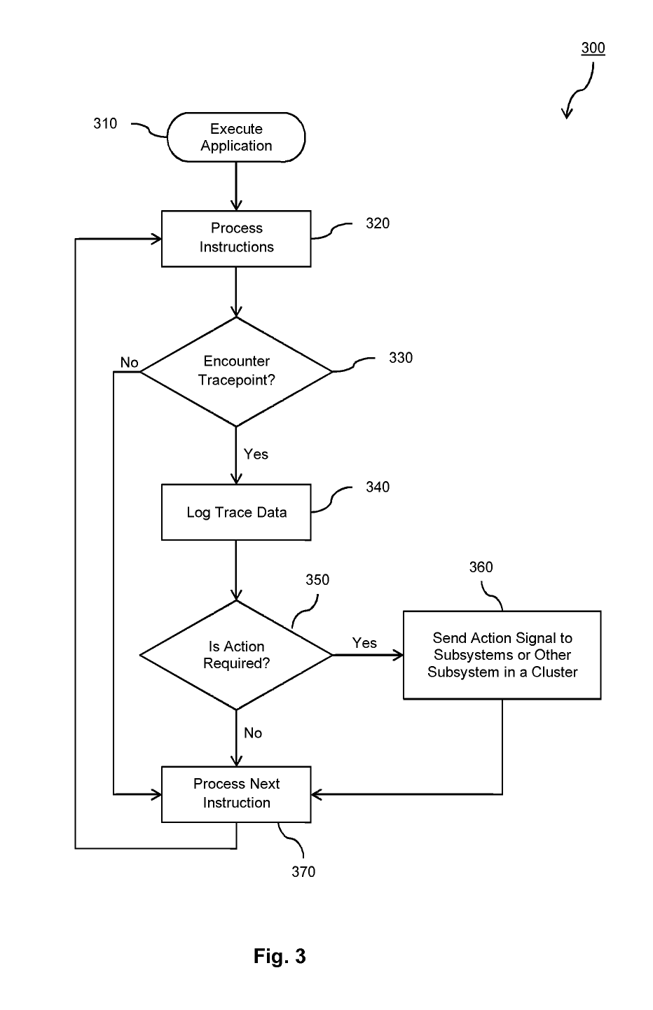

FIG. 3 illustrates an example method 300 according to some embodiments. In block 310, an application is executed in a node such as, for example, node A 102 in system 100. The application may be loaded from a storage controller associated with cluster 101 or from an external source. Once the application is loaded, the processor, such as, for example CPU 110 of system 100 may begin processing the application's instructions, as shown in block 320.

As the processor processes the application's instructions the processor determines whether a particular instruction is actually a tracepoint in block 330. A tracepoint may be identified by the processor as an interrupt or another particular instruction. If the instruction is not a tracepoint, the processor continues processing the instruction and then continues with processing the next instruction, represented by block 370. If the instruction is a tracepoint, the tracepoint is logged in block 340. The tracepoint may be logged by buffering data that includes, for example, the state of the processor, or the environment of the system or an application. The buffered data may be written to a log file such as, for example, tracepoint log 162 in system 100.

Next, in block 350, it is determined whether the tracepoint requires further action to be taken. If further action is not to be taken, the processor continues to process the next instruction, as shown in block 370. If further action is to be taken, however, action data associated with the tracepoint is processed to determine the actions to be taken. In some embodiments, the action data may indicate, for example, values that correspond to actions in a lookup table, values that correspond to processor instructions, values that correspond to application events, values that identify tracepoints, or values that indicate the location of an external server. In block 360, the determined actions are processed. Once the actions are processed, the processor continues to process next instruction, shown in block 370.

It should also be noted that method 300 may be applied to any computing cluster, not just clusters described in system 100 or 200.

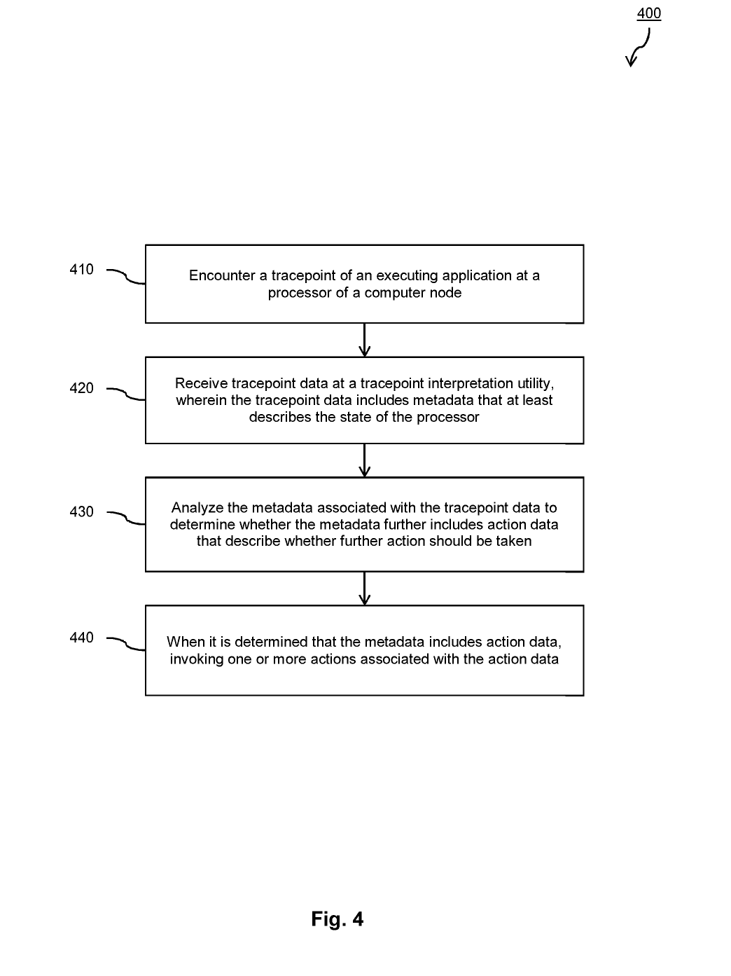

FIG. 4 illustrates an example method 400 according to some embodiments. Method 400 may be carried out by, for example, cluster 100, cluster 200, or any other similarly configured cluster. Method 400, however, is not intended to limit the other functions that may be carried out by a cluster implementing this method.

Block 410 includes encountering a tracepoint of an executing application at a processor of a computer node such as, for example, CPU 110. Tracepoints may be encountered as the processor processes instructions that make up the application. Tracepoints, however, may be processed in a different manner than other instructions. For example, when a tracepoint is encountered, the processor may execute instruction that transmit data describing the state of the processor and metadata (e.g., data describing the environment of the processor) to a component for further processing. An example of such a component is the tracepoint interpretation utility 130 in system 100.

Block 420 includes receiving tracepoint data at a tracepoint interpretation utility. The tracepoint data includes the data describing the processor's state and may also include any associated metadata that describes the environment of the system or application. Tracepoint data may be received by the tracepoint interpretation utility via, for example, a pointer to a memory buffer that includes the data. Further the tracepoint interpretation utility may be implemented as particular instructions processed by the processor or may be included in a component external to the current node. These examples, however, are not intended to limit the embodiments.

Block 430 includes analyzing the metadata associated with the tracepoint data to determine whether the metadata further includes action data that describe whether further action should be taken. As described above in reference to FIG. 3, the action data may include values that correspond to, for example, actions to be carried out by other components, instructions to be carried out by the processor, events to be processed by other applications, or messages to be sent to other applications or nodes within the cluster. Analyzing the metadata may include, for example, identifying whether action data exists and extracting the actions to be invoked from the action data. Analyzing the metadata may also include looking up values in an action table. Since action data can correspond to many actions in many different ways, the example provided herein are not intended to limit the embodiments.

Block 440 includes invoking one or more actions associated with the action data when it is determined that the metadata includes action data. In some embodiments, action data may include, for example, sending a message to a support server. In these embodiments, block 440 also includes receiving further action data in response to sending the message and invoking the actions included in the received action data. In some embodiments, block 440 includes sending a message to applications in the current node or applications in another node within the cluster. In these embodiments messaging functionality may be carried out by, for example, messaging utility 140 in system 100. In some embodiments, block 440 includes modifying a tracepoint by setting the tracepoint to an ON or OFF state or by setting the tracepoint's action data to an ACTION ON or ACTION OFF state. These actions may be processed by, for example, the tracepoint definition utility 150 in system 100. The actions that may be invoked, as described above, are not intended to limit the embodiments.

The scope of embodiments is not limited to the actions shown in FIG. 4. Other embodiments may add, omit, rearrange, or modify one or more actions as appropriate. For instance, some embodiments may include invoking one or more actions by sending a message throughout the cluster while other embodiments may limit invocation of actions to a local node.

It should be noted that the examples above are given in the context of a cluster that can implement a number of network services such as, for example, a network storage system. The scope of embodiments, however, is not so limited. Rather, the concepts described above may be implemented in any type of computing cluster, where each cluster processes tracepoints unique to the nodes in its cluster.

It should also be noted that the actions of FIG. 4 may be applied to any computing cluster, not just clusters described herein.

As described above, the embodiments allow a tracepoint to affect a change in a cluster-based computer system. The embodiments provide an advantage over conventional systems because tracepoints of conventional systems only log tracepoint data and do not allow tracepoints to modify data parameters (e.g., metadata) within the cluster. Allowing tracepoints to affect the system, as provided by the embodiments, allows software developers to automatically expand the amount of data generated when an error state is encountered in an application.

Particularly in multi-node cluster systems, an application error encountered in one node of the cluster such as, for example, an error encountered by accessing an invalid location in a memory buffer, may be caused by an application executing on another node. To diagnose this problem, the embodiments may automatically activate tracepoints in other applications that are associated with instructions that access the memory buffer. In other words, when a tracepoint is encountered, the embodiments process tracepoints by not only buffering state data but also by invoking actions associated with the tracepoint, such as, for example, activating related tracepoints in other applications executing on nodes in the cluster. Activating related tracepoints allows state data to be generated and logged, for example, each time a similar error is encountered or when the memory buffer is accessed. This additional data may assist developers in identifying the source of the problem that, in conventional systems, may be difficult to locate.

When implemented via computer-executable instructions, various elements of embodiments of the present disclosure are in essence the software code defining the operations of such various elements. The executable instructions or software code may be obtained from a non-transient, tangible readable medium (e.g., a hard drive media, optical media, RAM, EPROM, EEPROM, tape media, cartridge media, flash memory, ROM, memory stick, network storage device, and/or the like). In fact, readable media can include any medium that can store information.

In the embodiments described above, example cluster 101 and its included nodes include processor-based devices and may include general-purpose processors or specially-adapted processors (e.g., an Application Specific Integrated Circuit). Such processor-based devices may include or otherwise access the non-transient, tangible, machine readable media to read and execute the code. By executing the code, the one or more processors perform the actions of methods 300 and/or 400 as described above.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and in a manner consistent with the scope of the embodiments disclosed herein.

What is claimed is:

1. A method of invoking an action in response to encountering a tracepoint of an executing application comprising:
encountering a tracepoint of the executing application at a processor of a computer node;
receiving tracepoint data at a tracepoint interpretation utility, wherein the tracepoint data includes metadata that describes the state of the processor;
analyzing the metadata associated with the tracepoint data to determine whether the metadata further includes action data that describe whether further action should be taken, wherein the action data describes an action other than buffering the tracepoint data; and
when it is determined that the metadata includes action data, invoking one or more actions associated with the action data.

2. The method of claim 1, wherein the action data describes activating another tracepoint in an application enabled to execute on the computing node.

3. The method of claim 2, wherein the action data further describes activating action data in the another tracepoint.

4. The method of claim 1, wherein the action data describes activating another tracepoint in an application enabled to execute on another computing node.

5. The method of claim 1, wherein invoking the one or more actions associated with the action data includes:
locating an action message from an action table based on the action data; and
sending a message to another application that is configured to receive and process the message to invoke the action that corresponds to the action message.

6. The method of claim 1, wherein the action data describes deactivating another tracepoint in an application enabled to execute on the computing node.

7. The method of claim 1, wherein the action data describes deactivating action data in another tracepoint in an application enabled to execute on the computing node.

8. The method of claim 1, wherein invoking the one or more actions associated with the action data includes transmitting the tracepoint data and metadata to a support server.

9. The method of claim 1, further comprising:
receiving metadata from the support server, the metadata including action data that activates one or more tracepoints; and
invoking the action data received from the support server.

10. The method of claim 1, wherein invoking the one or more actions associated with the action data includes modifying the metadata associated with a tracepoint to include additional tracepoint behaviors that correspond to a tracepoint behavior table.

11. A computer system comprising:
a node including a processor-based device executing computer-readable code to provide functionality;
an application running on the processor-based device and experiencing a plurality of states of a state machine, the application encountering a tracepoint in response to experiencing one of the states; and
a tracepoint interpreting utility running on the processor-based device and configured to:
receive the tracepoint, wherein the tracepoint includes data describing the tracepoint and metadata describing the state of the processor;
determine whether the metadata further includes action data that describes one or more actions to be invoked; and
when it is determined that the metadata describes one or more action, invoking the one or more actions.

12. The computer system of claim 11, further comprising:
a tracepoint defining utility configured to affect metadata of at least one of a plurality of tracepoints of the application.

13. The computer system of claim 11, wherein the tracepoint interpreting utility is further configured to affect metadata associated with one or more applications executing on one or more other nodes operably connected to the node.

14. The computer system of claim 11, wherein the tracepoint interpreting utility is further configured to invoke the one or more actions by:
retrieving one or more actions based on the action data from an action table;
invoking the one or more actions retrieved from the action table.

15. The computer system of claim 11, wherein the tracepoint interpreting utility is further configured to invoke the one or more actions by:
retrieving one or more action messages based on the action data from an action table, the action messages describing actions to be invoked; and
sending the one or more action messages to one or more applications configured to execute on the node.

16. The computer system of claim 11, wherein the tracepoint interpreting utility is further configured to invoke the one or more actions by transmitting the tracepoint data to a remote support server.

17. The computer system of claim 11, wherein the tracepoint interpreting utility is further configured to invoke the one or more actions by modifying the metadata associated with a tracepoint to include additional tracepoint behaviors that correspond to a tracepoint behavior table.

18. A method of affecting changes throughout a cluster in a multi-node cluster-based computer system, each node including a processor that executes application, comprising:
processing an instruction associated with an application at a processor in one of a plurality of nodes in the cluster-based computer system;
encountering an error as a result of processing the instruction, the error being associated with a tracepoint;
pausing the processing of the application's instructions while the processor:
stores state data that describes the state of the processor to a memory buffer, the state data including action data that identifies actions to be invoked throughout the cluster; and
notifies a messaging utility that state data has been buffered; and
in response to the notification:
accessing via the messaging utility the state data and associated action data;
determining from the action data the actions to be invoked throughout the cluster; and
invoking the actions throughout the cluster.

19. The method of claim 18, wherein invoking the actions throughout the cluster includes:
sending a message via the messaging utility to other nodes within the cluster;
receiving the message at the other nodes via their respective messaging utilities;
for each respective messaging utility in the other nodes:
analyzing the message to determine one or more tracepoints in one or more applications executing on the node that require activation; and
transmitting an event the each of the one or more applications executing on the node that, when processed by each application, activated the requires tracepoints.

20. The method of claim 19, further comprising:
logging state data in a memory buffer each time an activated tracepoint is encountered by is respective processor.
